(19) United States
(12) Patent Application Publication
(10) Pub. No.: US 2010/0119658 A1
(43) Pub. Date: May 13, 2010

(54) HOT AIR PUFFED PET TREAT AND METHOD OF MAKING

(76) Inventor: Mark Levin, Papillion, NE (US)

Correspondence Address: POLSINELLI SHUGHART PC, 700 W. 47TH STREET, SUITE 1000, KANSAS CITY, MO, 64112-1802, US

(21) Appl. No.: 12/557,432

(22) Filed: Sep. 10, 2009

Related U.S. Application Data
(60) Provisional application No. 61/095,678, filed on Sep. 10, 2008.

(51) Int. Cl. A23K 1/10; A23K 1/00; A23P 1/14

(52) U.S. Cl. 426/92; 426/641; 426/644; 426/647; 426/445; 426/442; 426/302; 426/274

(57) ABSTRACT

A puffed pet treat and method of making are disclosed. The puffed pet treat is comprised of a starting material that is an animal part, which is treated, sliced into small portions, and exposed to high velocity hot air causing rapid heat transfer within the small portions causing the water contained in the material as moisture to undergo a rapid phase change from liquid to steam which softens and expands the material thereby forming a puffed product.

### RELATED APPLICATIONS

This patent application claims priority from U.S. provisional patent application Ser. No. 61/095,678, filed Sep. 10, 2008, the contents of which is incorporated herein by reference in its entirety.

### FIELD OF USE

The present invention relates to a puffed pet treat formed from an animal part and a method of making the puffed treat, as well as an alternative treat that provides two types of distinctly treated animal parts. The puffed treat of the present invention is suitable for pet consumption and is formed by the process that includes rapid heat transfer as a puffing mechanism.

### BACKGROUND

Pet owners have a multitude of pet treats to choose from, including rawhide, jerky treats, dental treats, soft treats, and biscuits. Pet treats are usually made of either animal parts or starch-based material. Regardless of the ingredients, dogs and cats tend to prefer treats that contain meat or are flavored to taste like meat. Protein based products are desired because dogs have an attraction to protein.

Some animal-based treats are made from animal by-products, as the by-products are typically low cost and high in protein. Exemplary by-products include ears, snouts, hooves, and other animal parts. One disadvantage associated with these types of products is retention of moisture, which can lead to bacteria, mold, or yeast growth on the product. A treat that has a moisture level of at least 14% by weight or a water activity of above 0.65 can harbor bacteria and other organisms, which have sufficient water to grow. Thus, a treat with a low water activity level, preferably a water activity level of 0.3 or below, or a moisture level below 14% by weight, is preferred. Current dry treats with a low water activity level can be hard and sometimes brittle making them difficult for pets to chew. This is especially true for infant and elderly pets. The hardness and other characteristics typically result from certain preparation techniques. As such, it is desired to have a dry treat that is not overly hard and can be easily chewed.

Another disadvantage of treats made from animal parts, such as rawhide, is that they are not readily digestible by the animal. This can lead to the treat expanding in the stomach or intestine of the animal causing the animal to become sick and possibly die. Thus, when using animal by-products it is necessary to treat the raw material such that it changes the character sufficiently to be digested.

Most chews or treats made from animal by-products are produced by the methods of either frying or baking. Frying results in a treat with a higher fat content, which can have adverse health effects on a pet, such as weight gain, high cholesterol, and other health concerns. While baking a treat does not have the disadvantage of added fat, baked animal parts are often difficult for pets to consume. Baking slowly removes water, which can form an undesirable product.

Another common type of pet treat is one that is comprised of starch or carbohydrate materials, such as flour, seeds, or various types of grains. These compositions also may include additional materials such as humectants and nutraceuticals. Starch materials provide structure to the pet treats and result in treats that are easy for pets to consume. Starch-based treats, however, have a number of problems associated with them, such as lack of protein. Also, starch products that lack protein or contain little protein are often over-consumed by pets, which leads to overeating and weight gain.

What is desired in the art is a treat that is easy for pets to consume and that contains a high level of protein. It is further desired that the treat be formed from an animal part that resultingly has a comparatively low level of moisture and is easy to eat. Preferably, such treat will not have extraneous fat or be hard or brittle. Another advantageous characteristic to be desired is a treat that is readily digestible by the animal.

### SUMMARY OF THE INVENTION

The present invention is directed towards a puffed pet treat, which comprises a dried and treated collagen-based animal by-product that is puffed by rapid heat transfer. The resultant pet treat has an inflated appearance, low water activity, no added fat, and can be readily digested. The present invention also includes a method for producing the puffed pet treat, whereby the method includes using a convection heat air source to cause a phase change in the indigenous water or water absorbed prior to drying contained in the animal by-product. The resultant phase change turns the water into steam causing a rapid expansion. This expansion leads to the presentation of a puffed appearance. As such, the method must be such that the rapid phase change results when the treated starting material is heated. Further, the puffed pet treat is made from collagen-based animal by-products, which gives the treat a meaty taste making it palatable to pets. The resultant puffed pet treat is crunchy and has an increased volume and thickness. Advantageously, the treat of the present invention is digestible by pets, making the treat safe for consumption.

The process for producing the puffed pet treat includes treating the collagen-based animal by-product. The by-product can be taken from any of a variety of mammal, avian, and fish species. In a preferred embodiment, the animal by-product is sliced or cut into small portions before puffing, but this is not required. Preferably, the collagen-based animal by-product is rawhide derived from bovine or porcine. The collagen-based animal by-products are treated according to preparation processes customarily practiced on rawhide. The treatment includes contacting the animal by-product with both basic and acidic solutions for a period of time sufficient to cause an alteration in the protein or collagen in the raw animal by-product. The treatment must be such that when the indigenous water in the animal by-product undergoes a phase change the protein or collagen within the animal by-product can separate to expand, forming a puffed product.

After the collagen-based animal by-product is treated and dried, such that the moisture level is between 125 and 20%, it is connected with a convection heat air source such that rapid heat transfer takes place within the treated animal by-product. The rapid heat transfer causes the moisture within the treated starting material to soften the starting material and expand the starting material as the phase change from liquid to steam occurs quickly. This rapid phase change forces the material to expand, resulting in a puffed treat. The process produces crunchy puffed pet treats that are palatable to pets.

The resultant puffed pet treat provides advantages over previous treats formed from collagen-based animal by-products, since puffing removes moisture from the treat forms a crunchy product that is generally desired. Additionally, the pre-treatment and rapid phase change of indigenous moisture creates a final product that is readily digestible by the pet. This removal of moisture prevents the build-up of bacteria on or within the treat, which is a known problem in other treats made from animal parts. Additionally, the puffed pet treat provides a good source of protein for pets and avoids some of the problems associated with carbohydrate-based treats, such as weight gain. The puffed pet treat is easy for pets to chew and digest, especially infant, elderly, or small breed pets (including cats) who would not typically chew rawhide-like treats, and provides a lower calorie alternative to traditional animal-based treats since puffing results in a larger treat with less animal material per volume of treat.

### DETAILED DESCRIPTION

In accordance with the present invention, a puffed pet treat and method of making a puffed pet treat have been developed. The resultant treat is a puffed collagen-based animal by-product that is easily digestible by pets and has air pockets, making it crunchy. The treat is not fried or baked, but is formed using a convection heat air source of hot air as a puffing mechanism. The puffing procedure results in a treat that becomes distended when the moisture contained therein is rapidly heated with hot air. The rapid heating causes the water that was present in the starting material to quickly change to steam. The rapid phase change within the animal by-product causes it to soften and expand, producing a treat having an inflated appearance. The method of the present invention produces a treat that does not have extraneous fat, nor a treat that is hard or liable to fracture easily into sharp portions. Additionally, the resultant treat is digestible by pets, due to the treatment of the collagen-based animal by-product, prior to puffing, and the rapid heat transfer and phase change of moisture the treat undergoes during the puffing process. Further, the product has a water activity level below 0.65, preferably from 0.3 to 0.65, which means microbial growth is minimized within the pet treat. Additionally, the treat has characteristics that are believed desired by humans as purchasers, such as the safety of the treat, given the digestibility, and a pet's affinity for animal-based treats. The resultant puffed treat is formed from a collagen-based animal by-product that has been treated according to normal processes known in the industry for treating rawhide, is unbleached, has a water activity level below 0.65 after puffing, and exhibits increased volume, hardness, and density as compared to the unpuffed starting material.

The puffed pet treat is formed from a starting material that is a collagen-based animal by-product. The source from which the animal product is derived includes, but is not limited to, mammals, reptiles, ayes, amphibians, fish, and insects. In a preferred embodiment, the animal source is bovine, porcine, avian species, marsupials, and game, more preferably, the animal source is poultry, pork, cattle, lamb, buffalo, deer, elk, or any other animal source used in the industry. In a most preferred embodiment, the animal source is either bovine or porcine. The starting material for the puffed pet treat can be any of a variety of animal by-products which are collagen-based, including, but not limited to, hides, tendons, ears, or any other animal part containing connective tissue or cartilage. Such parts are typically not desired for human consumption because they are selected layers of skin, connective tissue or cartilage. In a most preferred embodiment, rawhide is used. The collagen-based animal product is preferably treated according to normal processes known in the industry for treating rawhide, but depends on the animal by-product used, however, the animal by-product is not bleached prior to puffing.

The method for forming the puffed pet treat will depend upon the starting material. In a preferred embodiment, the starting material is hide or skin. Skin or hide that is treated according to normal processes known in the industry for treating rawhide can be used for purposes of the present invention. Treatment of collagen based animal by-products generally comprises treatment with a base and an acid. In a preferred embodiment, the treatment of animal by-products comprises treatment with or more salts, lime, one or more acids, a pH neutralizing agent, and water. In a preferred embodiment, the treatment of the collagen-based animal by-product, preferably rawhide, generally comprises the following: a) the animal by-product is removed from the animal and salted; b) the animal by-product is soaked in a solution of lime and acid to remove hair; c) the animal by-product is treated with an agent that removes the lime from the skin; d) an alkaline solution is contacted with the animal by-product to make it alkaline; and e) the animal by-product is soaked in water. These steps can be repeated. The methods of the present invention do not require the use of lime, as any element suitable for removing hair from a raw animal by-product will work for purposes of the present invention. After soaking, excess fat and tissue are scraped from the skin so that it can be dried and molded into a shape. Preferably, the skin is de-limed by use of a solution which protonates basic groups of the collagen and neutralizes solution alkali chemicals. Preferably, this solution is selected from the group consisting of ammonium chloride, ammonium sulfate, boric acid, acetic acid, formic acid, lactic acid, carbonic acid, and combinations thereof. Any solution that will react with and remove traces of lime from the skin can be used. In a most preferred embodiment, the solution used to de-lime the skin is ammonium chloride. After de-liming, the skin is washed with a solution that neutralizes the pH of the skin, such that the pH is about 6-7. Any solution that restores pH can be used for purposes of the present invention. Preferably, the solution used is a mixture of sodium chloride and hydrochloric acid. After the pH is restored, the skin is then dried by any manner used in the industry, for example, in direct sunlight, in a commercial dryer, etc. After drying, the skin may be re-hydrated before molding into a desirable shape. Preferably, the skin is unbleached and re-hydrated with water prior to molding. In a preferred embodiment, the treatment steps described above are repeated multiple times. Specifically, it is preferred that the treatment of the hide includes multiple treatments wherein steps c) and d) above, singularly or in combination, are repeated at least once, more preferably, at least twice, and, most preferably, at least three times. Resultantly, the treatment causes protein and collagen to separate forming a puffed product during heating and drying the layers of the animal by-product.

In order to have successful puffing take place, a certain amount of moisture must be present in the starting material following treatment. Preferably the moisture content in the treated starting material is between about 6%-20%, preferably 9%, even more preferably between about 9%-18%, preferably 10%, more preferably between about 10%-16%, preferably 12%, more preferably between about 6-15%, and most preferably 15% moisture by volume of the animal part. As is disclosed in greater detail below, puffing will not occur if the moisture content of the starting material falls below 6% since the product will be too dry to expand. A moisture content over 20% by volume of the animal part will also prevent puffing since it will take more time to remove the moisture and the product will end up cooling before it can be puffed.

After the starting material is treated, the starting material is preferably sliced into small portions, however such slicing is not required. While any size and shape reasonable for pet consumption will work for purposes of the present invention, the animal by-product should be an appropriate size and thickness so that the convection heated air source can heat the entire animal by-product in a uniform manner. In a preferred embodiment, the slices have a square shape with each side of the square being about 3-7 cm in length, with the most preferred size being a square with each side being about 5 cm on each side. Alternately, the slices are cut into oval shapes having a radius of about 3-7 cm, more preferably about 5 cm, on the largest radius. Specifically, the size of the slices should be such that the outer surface can be heated in a time frame similar to the interior. The animal by-product must also be an appropriate thickness for puffing depending on the convection heat air source. In a preferred embodiment in which the animal by-product is sliced, the starting material is preferably sliced to a thickness of 0.001-1.0 cm (cross-section), more preferably the thickness is about 0.005 cm to 0.8 cm, more preferably the thickness is about 0.008 cm-0.5 cm, and most preferably the thickness is about 0.1 cm.

For purposes of puffing, the animal by-product is exposed to a convection heat air source in order to form the puffed pet treat. This can be a batch or continuous process. Any heat source which achieves a rapid phase change in the treat without scalding, burning, or incinerating the starting material, and thus achieving a puffed product, will work for purposes of the present invention. Preferably, a convection heat air source is used such that the air is circulating around the animal by-product. Alternatively, a heat source wherein the animal by-product is moving through the hot air, while the hot air remains stagnant, will also work for purposes of the present invention. In a preferred embodiment, the hot air source is one with the temperature and pressure range of that of an industrial air popcorn popper or impingement oven. Preferably, the hot air source has a temperature range of 212-525° F. The hot air source must be able to provide movement of the hot air or the animal by-product within the hot air. A rapid heat transfer causing a rapid phase change of the treat material is needed for the animal by-product to puff properly. This convection heat air source causes the moisture contained in the animal by-product to briefly soften and then expand as the moisture quickly undergoes a phase change from liquid to steam. If the phase change from liquid to steam does not occur quickly, liquid contained in the slice will soften the slice but the animal by-product will not expand, which will prevent puffing and produce a softer pet treat. If the slice contains too much moisture, the animal by-product will cool before the phase change from liquid to steam occurs and the animal by-product will not expand and puff. If the animal by-product does not contain enough moisture, the animal by-product will not soften due to insufficient liquid and the animal by-product will not puff. The liquid contained in the animal part must quickly turn to steam, since it is the steam that likely causes the animal part to swell and puff. Specifically, micro cells within the layers of the animal part burst when exposed to hot air. The bursting of micro cells results in a pressure build-up within the animal part, which causes the layers of the animal part to separate as the hot air converts the liquid to steam. This pressure drives the change of phase from liquid to steam and causes puffing. The animal part is puffed for a time sufficient to enable the rapid phase change to occur without burning the animal part. The preferred time for puffing is approximately 10 seconds to 2 minutes, but may be extended or reduced depending on the type, size, and thickness of the starting material. Additionally, the preferred puffing time depends on the convection heat air source and temperature of the air, as well as the mass of animal by-product placed under the hot air source.

In a preferred embodiment, the treat of the present invention, in its final form, has a bulk density, as measured by standard procedures, of about 1 to 10 ml/g. Preferably, the bulk density is at least 1 ml/g, more preferably, at least 1.96 ml/g, even more preferably, at least 2.5 ml/g, still more preferably, at least 4 ml/g, more preferably, at least 4.11 ml/g, still more preferably, at least 5.4 ml/g, even more preferably, at least 5.92 ml/g, and, most preferably, at least 6.25 ml/g. Preferably, rawhide has an initial bulk density of 4 ml/g, prior to puffing. Preferably, the starting material puffs to a thickness that is at least 0.25 times the thickness of the starting material, more preferably, at least one time the thickness of the starting material, more preferably, at least twice the thickness of the starting material, more preferably at least 2.5 times the thickness of the starting material, and even more preferably, at least 12.5 times the thickness of the starting material. For a starting material with a thickness of about 0.08cm, the resulting thickness of a cross-section of the puffed treat is preferably from about 0.2 cm to 1 cm. Preferably, the volume of the puffed animal by-product is increased by at least 25% from the starting material, even more preferably, at least 35%, even more preferably, at least 50%, even more preferably, at least 75%, still more preferably, at least 100%, more preferably, at least 125%, still more preferably, at least 150%, still more preferably, at least 175%, more preferably, at least 200%, even more preferably, at least 300%, more preferably, at least 400%, and still more preferably at least 500%. In a preferred embodiment, the volume of the puffed animal by-product is at least 25% to 2000% larger than that of the starting material.

The puffed pet treat of the present invention is digestible for pets. This is a great advantage over traditional non-puffed rawhide treats. It was found that rawhide treated with bleach before exposure to a hot air source did not exhibit puffing. This bleached rawhide also did not digest when exposed to gastric and intestinal fluids. In contrast, it was a surprisingly found that the puffed pet treats of the present invention, which were treated according to the present invention and left unbleached prior to puffing, were found to be digestible when exposed to gastric and intestinal fluids. Additionally, it was found that treats that were puffed at a higher temperature digested more quickly than those treats puffed at a lower temperature. The digestibility of the treats of the present invention is a great advantage, as this avoids problems associated with traditional rawhide treats, in that they can become lodged in the stomach and intestine of an animal, since they are not digestible, and cause various health problems and death. The treats of the present invention overcome the disadvantages of traditional rawhide and provide a safe alternative that is attractive to pets.

In an alternate embodiment, the treat of the present invention incorporates more than one hide type. A “hide type”, for purposes of the present invention, refers to the animal source or the treatment of the animal hide. According to this meaning, a “different hide type” would be either a hide obtained from a different animal source; a hide of the same animal source which has been processed in a different manner than the first; or a hide from a different animal source which has been processed in a different manner than the first. Preferably, the treat incorporates more than one hide type, wherein one hide has been processed in a different manner. Even more preferably, the treat incorporates a bleached hide with an unbleached hide. In this preferred embodiment, a slice of the bleached hide is layered between slices of unbleached hide and affixed together. Any configuration of different hide types, using different shapes, sizes, etc., will work for purposes of the present invention as long as the shapes, sizes and configurations are of appropriate size and thickness so that the high velocity hot air can heat the entire treat in a uniform manner. Preferably, the slices of hide are affixed with an edible polymer, a starch-based adhesive, a rawhide string, or combinations thereof. After the treat of different hide types is exposed to a heat source, preferably a convection heat air source, and rapid phase change takes place, the unbleached portions present a puffed appearance, while the bleached portion presents an appearance that is less puffed than the unbleached counterpart. This results in a treat having a unique look that is attractive to pets.

After puffing, the treats may optionally be flavored with any flavoring that is favored by pets, such as chicken, liver, beef, bacon, cheese, peanut butter, or any other flavoring used in the industry. The resultant treat has a puffed appearance and is a light, crunchy treat, having a flavor that is palatable to pets, and will have a water activity of less than 0.65.

### DEFINITIONS

“Collagen-based animal by-product”, “Animal part”, or “Animal by-product,” for purposes of the present invention refers to a part of an animal containing a collagen structure suitable for consumption by pets including, but not limited to, ears, hide, tendons, or any other animal part containing connective tissue or cartilage. The animal source can be mammal, ayes, reptiles, amphibians, insects, worms, and the like. Preferably, the animal part is taken from bovine, poultry, buffalo, deer, lamb, or porcine, or any other animal source used in the industry.

“Rapid heat transfer,” refers to the process that occurs when a volume of high velocity air at high temperature is forced into a substance such that the heat from the air is quickly transferred to the substance, thus raising the temperature of the substance at a rapid pace.

“Rapid phase change,” refers to the change of the state of moisture such that liquid becomes steam in a short time frame. Preferably this short time frame is under 30 seconds for each molecule of liquid, which may change phase simultaneously or in succession, creating a puffing time for the treats of the present invention to preferably take 15 seconds to 2 minutes.

“Raw,” refers to an animal part that is not heated above 160° F. or not substantially denatured.

“Puffing,” refers to a process resulting in a material filled with air such that the material expands or swells giving it an inflated appearance. The inflated appearance is caused by convection heat air entering the inner portion of the material, whereby the liquid contained in the material undergoes a rapid phase change to steam, which softens the material and forces the material to expand in order to accommodate the volume of air present therein, causing the material to have an inflated appearance. A puffed material normally experiences at least a two-fold increase in internal air volume compared to its original size prior to puffing. Puffed material usually has a lighter texture due to the amount of air present in the material.

“Pet(s),” refer to any domesticated animal normally kept as a companion animal by humans. This includes mammals, birds, and reptiles, among others. Preferably, the treat is intended for a cat or dog.

### Examples

The following examples are for illustrative purposes only and are not to be construed as limiting the scope of the subject invention.

### Example 1

### This Example Illustrates One Embodiment of the Puffed Pet Treat of the Present Invention

### Materials and Methods

Hides from both pigs and cattle were obtained. Hides were treated following the industry-accepted method of treatment including the following steps:
1. Treatment with lime and sulfuric acid (to remove hair).
2. Treatment with Ammonium Chloride to remove the lime from the hides.
3. Next, a sodium chloride and hydrochloric acid solution was used on the hides.
4. The hides were then washed with water and dried.

Steps 2 and 3 were repeated at least two times. The hides were left unbleached. Slices of the hides were cut into various shapes such as squares, ovals, and rectangles. The square slices were about 2 inches on each side. The rectangles and ovals had a similar surface area. All slices used were 0.05 cm to 0.15 cm thick. The slices were then exposed to heat using a heat source that provided hot air at a temperature and pressure causing rapid heat transfer and a rapid phase change in the moisture of the treat, causing the treat to puff without burning, scalding, or incinerating. The hot air source used was similar to that of an industrial air popcorn popper, having a temperature range of about 212° F. to 500° F. The slices were then left to cool.

### Results and Conclusions

TABLE 1
Results of Puffing

| | | | Post-puffed | |
|---|---|---|---|---|
| | | Pre-puffed | thickness | |
| Animal | | thickness | (resultant | Resultant |
| Source | Shape | (original) | treat) | Treat |
| Cattle skin | Square (2 | .08 cm | 1 cm | 12.5 times as |
| | inches by 2 | | | thick as |
| | inches) | | | original |
| Pig skin | Square (2 | .10 cm | .20 cm | 2 times as |
| | inches by 2 | | | thick as |
| | inches) | | | original |
| Pig skin | Oval that was | .08 cm | .20 cm | 2.5 times as |
| | 2.5 inches | | | thick as |
| | across at | | | original |
| | biggest point | | | |

The results show that all slices were puffed to at least twice the thickness of the original slice. The cattle skin puffed by as much as 12.5 times the thickness of the original. The result was a puffed treat wherein some of the moisture was removed. Due to the rapid heat transfer caused by exposing the skin portion to the rapid heat transfer mechanism, an air popcorn popper, the liquid contained in the material underwent a rapid phase change to steam, which forced the skin to expand in order to accommodate the volume of air present therein. All resultant treats were light and crunchy.

### Example 2

This example illustrates an alternate embodiment of the present invention wherein different types of hides were used with each hide being exposed to a different treatment process.

### Materials and Methods

Hide from a pig was treated according to the method in Example 1, above. Of the resultant portions or slices, some were bleached after the treatment process and some were not bleached. A 2 inch by 2 inch square bleached portion was placed sandwiched between two 2 inch by 2 inch square unbleached portions. The three portions were affixed with rawhide string on each corner such that the portions were affixed in four places. The affixed portions were then puffed according to the procedure in Example 1 and left to cool.

### Results and Conclusions

The results were that the unbleached portions of hide puffed to a similar degree of the pork slices puffed in Example 1, such that they expanded at least 2 times the thickness of the original portion. Large pockets of air also formed in between the layers of the treat such that the layers separated except on the corners where the layers had been affixed. The inner unbleached rawhide portion did not puff, but in certain cases, changed shape slightly. The resultant treat was light and crunchy with a unique look and texture.

### Example 3

This example illustrates different treatments on portions of rawhide.

### Materials and Methods

The treatment steps used are as follows:
1. Hide removed from animal and salted
2. Treatment with lime and 10% concentrated sulfuric acid (to remove hair).
3. Treatment with 1.5% solution Ammonium Chloride to remove the lime from the hides.
4. Next, a 0.15% sodium chloride and 0.2% hydrochloric acid solution was used on the hides.
5. The hides were then washed with water and dried.

Variations on these steps were performed on different hides. Cattle hides were used for this experiment. In Group 1, fresh untreated hide was used. In Group 2, the hide was salted and treated with lime and sulfuric alkaline. The hides of Group 3 were regular unbleached rawhide processed according to steps 1-5 above. In Group 4, the hides were processed according to steps 1-5 above, with step 3 being repeated twice. The hides of Group 5 were processed according to steps 1-5 above, with step 4 being repeated twice. In Group 6, the hides were processed according to steps 1-5 above, with step 4 being repeated three times. The hides of Group 7 were processed according to steps 1-5 above, with steps 3 and 4 being repeated twice. In Group 8, the hides were processed according to steps 1-5 above and then bleached with hydrogen peroxide. All hides were cut into portions and puffed according to the method described in Example 1.

The procedure used for measuring the bulk density was as follows:
1. 100 ml of silica sand was measured in a graduated cylinder and weighed.
2. The cylinder was tapped 10 times and more sand was added to a total volume of 100 ml
3. The sand was removed and the item to be measured was added.
4. The sand was gradually placed back into the cylinder. The cylinder was tapped to allow sand to distribute around the items.
5. The difference in volume of sand without items and sand with items was recorded.

### Results and Discussion

TABLE 2
Hot Air Puffed Rawhide Bulk Density Comparison Bulk Density by Sand
Displacement

| | | | Total | | Volume | Bulk |
|---|---|---|---|---|---|---|
| | | Grams | Volume | Volume | (ml) | Density |
| | | of | Sand + | (ml) | Puffed | of |
| | | puffed | Puffed | sand | rawhide | Rawhide |
| Sample | Description | Rawhide | Rawhide | only | only | (ml/g) |
| Group 1 | Fresh Hide | Did not puff | | | | |
| | removed from | | | | | |
| | cow, salted and | | | | | |
| | dried | | | | | |
| Group 2 | Salted hide treated | 1.53 | 113 | 110 | 3 | 1.96 |
| | with lime & 10% | | | | | |
| | conc. sulphuric | | | | | |
| | alkaline | | | | | |
| Group 3 | Regular processed | 1.46 | 116 | 110 | 6 | 4.11 |
| | unbleached | | | | | |
| | rawhide | | | | | |
| Group 4 | Step #3 repeated: | 1.48 | 118 | 110 | 8 | 5.4 |
| | Two washings to | | | | | |
| | remove lime | | | | | |
| Group 5 | Step #4 repeated: | 1.69 | 120 | 110 | 10 | 5.92 |
| | rest of process std. | | | | | |
| Group 6 | Step #4 repeated | 1.6 | 120 | 110 | 10 | 6.25 |
| | 3x: rest of process | | | | | |
| | std. | | | | | |
| Group 7 | Step #3 and Step | 1.64 | 120 | 110 | 10 | 6.1 |
| | #4 repeated twice: | | | | | |
| | rest of process std. | | | | | |

The results indicated that those groups with extra treatments with ammonium chloride and a mixture of sodium chloride and hydrochloric acid exhibited a greater puff than those hides which were not subjected to the extra steps. The portion with the greatest puff volume was Group 4, with a bulk density of 6.25 ml/g and a volume of 10 ml. The lowest was Group 1, which did not exhibit any puffing. All groups, other than Group 1, exhibited some puffing. A bleached rawhide was also tested in this investigation and it was found that any puffing observed in the bleached rawhide was insignificant.

### Example 4

This example is to illustrate that the treats of the present invention are digestible to pets.

### Materials and Methods

Hides from cattle were treated according to the procedure in Example 1. Some of these hides were puffed according to the procedure in Example 1 and some were not puffed. The puffed hides were divided into two groups: A low temperature group and a high temperature group. The un-puffed hides were used as a control. All hides were exposed to stimulated gastric or intestinal fluid, with or without enzymes.

### Results and Discussion

TABLE 3
Results of Gastric and Intestinal Fluid Comparison

| | Low Temp Run 1- | High Temp Run 2 - | Raw Hide - Un- |
|---|---|---|---|
| | Puffed Hide | Puffed Hide | puffed |
| Simulated Gastric | No changes in 48 | Dissolve in approx | No changes in 48 |
| fluid (without | hours | 43 hours | hours |
| enzyme) | | | |
| Simulated Intestinal | Dissolves in approx | Dissolves in approx | No changes in 48 |
| fluid (without | 44 hours | 24 hours | hours |
| enzyme) | | | |
| Simulated Gastric | Dissolves within | Dissolves in 4 hours | No changes |
| fluid (with enzyme) | approx 18 hours | | |
| Simulated Intestinal | Dissolves within 1 | Dissolves within 1 | No changes |
| fluid (with enzyme) | hour | hour | |

The results show that the puffed hide is digestible in the stomach and the gut, while the un-puffed hide is not digestible in either. Additionally, those treats puffed at a higher temperature provided faster digestibility than those treats puffed at a lower temperature. A treat which is digestible is preferred by pet owners to avoid the dangers associated with large pieces of indigestible rawhide getting lodged in the stomach and intestinal track. These indigestible rawhide pieces can cause a blockage in an animal's system leading to illness or death. The treats of the present invention are safe for animals and provide a crunchy palatable treat that pets will enjoy and that is easily digestible.

While the invention has been explained in relation to exemplary embodiments, it is to be understood that various modifications thereof will become apparent to those skilled in the art upon reading the description. Therefore, it is to be understood that the invention disclosed herein is intended to cover such modifications as fall within the scope of the appended claims.

1. A puffed pet treat that has no extraneous fat and has a water activity level of less than 0.65, wherein the puffed pet treat is formed from a collagen-based animal by-product that has been treated with an acid and a base, and whereby the internal volume of the puffed pet treat is increased to at least 25% the volume of an untreated collagen-based animal by-product.

2. The puffed pet treat of claim 1, wherein the animal by-product is taken from a source selected from the group consisting of porcine, poultry, bovine, and lamb.

3. The puffed pet treat of claim 1, wherein the animal by-product is selected from the group consisting of hides, ears, and tendons.

4. The puffed pet treat of claim 1, wherein the pet treat is digestible.

5. The puffed pet treat of claim 3, wherein the animal by-product is hide.

6. The puffed pet treat of claim 3, wherein the collagen-based animal by-product is unbleached.

7. The puffed pet treat of claim 1, wherein the volume of the puffed pet treat is increased at least 100% by volume from that of the untreated collagen-based animal by-product.

8. The puffed pet treat of claim 1, wherein the volume of the puffed pet treat is increased at least 200% by volume from that of the untreated collagen-based animal by-product.

9. The puffed pet treat of claim 1, wherein the puffed pet treat is at least twice as thick as the starting material.

10. The puffed pet treat of claim 1, wherein the puffed pet treat is at least 12.5 times as thick as the starting material.

11. A method of making a puffed pet treat, comprising the steps:
a) slicing treated animal by-products to form a sliced by-product; and
b) exposing the sliced by-product to a convection heat air source causing a rapid heat transfer within the sliced animal by-product such that a puffed product is formed.

12. The method of claim 11, wherein the starting material is taken from a source selected from the group consisting of porcine, poultry, bovine, and lamb.

13. The method of claim 11, wherein the starting material is selected from the group consisting of hides, ears, and tendons.

14. The method of claim 11, wherein the sliced by-product has a moisture content of about 6% to about 20% by volume prior to the rapid heat transfer.

15. The method of claim 11, wherein the high velocity hot air is at a temperature of between about 212° F. to 500° F.

16. The method of claim 11, wherein the puffed pet treat is digestible.

17. The method of claim 11, wherein the starting material is hide.

18. The method of claim 11, wherein the slice animal by-product is unbleached.

19. The method of claim 18, further comprising a second starting material, which is bleached.

20. The method of claim 19, wherein the first starting material and the second starting material are affixed.

21. The method of claim 11, wherein the volume of the puffed pet treat is increased at least 25% by volume from that of an untreated collagen-based animal by-product.

22. The method of claim 11, wherein the volume of the puffed pet treat is increased at least 100% by volume from that of an untreated collagen-based animal by-product.

23. The method of claim 11, wherein the volume of the puffed pet treat is increased at least 200% by volume from that of an untreated collagen-based animal by-product.

24. The method of claim 11, wherein the puffed pet treat is at least twice as thick as the starting material.

25. The method of claim 11, wherein the puffed pet treat is at least 12.5 times as thick as the starting material.

26. A method of making a puffed pet treat comprising the steps:
a) obtaining an un-treated animal by-product;
b) treating the by-product with a base and an acid; and,
c) exposing the treated by-product to a convection heat air source causing a rapid phase change in the moisture of the animal by-product, causing the animal by-product to puff.

27. The method of claim 26, further comprising the step of treating the animal by-product with an agent which removes lime from the hide, prior to exposing the by-product to a hot air source.

28. The method of claim 26, further comprising the step of treating the hide with a solution used to create an alkaline pH within the hide prior to exposing the by-product to a hot air source.

29. The method of claim 26, wherein the animal by-product is not bleached.

30. The method of claim 27, wherein the agent which removes lime from the animal by-product protonates basic groups of the collagen and neutralizes solution alkali chemicals.

31. The method of claim 27, wherein the agent which removes lime from the hide is selected from the group consisting of ammonium chloride, ammonium sulfate, boric acid, acetic acid, formic acid, lactic acid, carbonic acid, and combinations thereof.

32. The method of claim 31, wherein the agent which removes lime from the hide is ammonium chloride.

33. The method of claim 28, wherein the solution used to create an alkaline pH is a mixture of sodium chloride and hydrochloric acid.

34. The method of claim 26, wherein the animal by-product is selected from the group consisting of pork, poultry, beef, and lamb.

35. The method of claim 26, wherein the volume of the puffed pet treat is increased at least 25% by volume from that of the untreated collagen-based animal by-product.

36. The method of claim 26, wherein the volume of the puffed pet treat is increased at least 100% by volume from that of the untreated collagen-based animal by-product.

37. The method of claim 26, wherein the volume of the puffed pet treat is increased at least 200% by volume from that of the untreated collagen-based animal by-product.

38. The method of claim 26, wherein the puffed pet treat is at least twice as thick as the untreated animal hide.

39. The method of claim 26, wherein the puffed pet treat is at least 12.5 times as thick as the untreated animal hide.

40. The method of claim 26, further comprising the step of coating the puffed animal hide with a flavoring agent.

41. The method of claim 40, wherein the flavoring is selected from the group consisting of chicken, liver, beef, bacon, cheese, and peanut butter.

42. A method of making a puffed pet treat comprising the steps of:
a) obtaining an untreated animal by-product, sourced from the group consisting of porcine or bovine;
b) salting the animal by-product;
c) treating the animal by-product with lime and sulfuric acid;
d) treating the animal by-product with ammonium chloride to remove the lime;
e) treating the animal by-product with sodium chloride and hydrochloric acid solution to make the animal by-product alkaline;
f) drying the animal by-product to at least 20% moisture level;
g) exposing the animal by-product to convection heat air that has a temperature from 212° F. to 500° F. for 15 seconds to 2 minutes causing a rapid heat transfer and phase change of moisture within the animal by-product such that the animal by-product presents a puffed appearance; and,
h) allowing the puffed animal by-product to cool.

43. The method of claim 40, wherein steps d) and e) are repeated twice.

44. The method of claim 40, wherein steps d) and e) are repeated three times.

45. A puffed rawhide pet treat, wherein the thickness of the pet treat is at least 0.25 to 12.5 times the thickness of the untreated rawhide, the pet treat has an increased volume of 25% to 500% from the starting material, a water activity level from 0.3 to 0.65, has no extraneous fat, and is digestible.

46. The pet treat of claim 45, further comprising the step of coating the puffed rawhide in a flavoring.

47. The pet treat of claim 45, wherein the pet treat is a square that is 5 cm on each side with a thickness of 1 cm.

48. The pet treat of claim 45, wherein the pet treat has a bulk density of at least 6.25 ml/g.

49. A pet treat comprising:
a) a first dried collagen-based puffed animal by-product that has been treated with one or more acids and bases, but not bleach; and,
b) a second dried collagen based animal by-product that has been treated with one or more acids and bases, and bleach that is attached to the first collagen-based puffed animal by-product.

50. A method of making a pet treat comprising:
a) treating a first raw collagen-based animal by-product with one or more acids and bases, but not bleach, and allowing the animal product to dry;
b) treating a second raw collagen based animal by-product with one or more acids and bases, bleach, and allowing the animal product to dry.
c) affixing the first animal by-product with the second animal by-product with an adhesive or other physical attachment; and,
d) exposing the affixed animal by-products to a convection heat air source, wherein a rapid phase change takes place within the moisture of the first animal by-product, producing a puffed appearance, and wherein the second animal by-product does not produce a puffed appearance.
